(19) United States
(12) Patent Application Publication
(10) Pub. No.: US 2020/0331220 A1
(43) Pub. Date: Oct. 22, 2020

(54) METHOD FOR MANUFACTURING ASPHERICAL OPTICAL MEMBER

(71) Applicant: Seoul National University R&DB Foundation, Seoul (KR)

(72) Inventors: Yong Taek HONG, Seoul (KR); Byoung Ho LEE, Seoul (KR); Seung Jae LEE, Gapyeong-gun (KR); Chan Hyung YOO, Seoul (KR); Hyung Soo YOON, Seoul (KR); Seung Hwan LEE, Seongnam-si (KR)

(73) Assignee: Seoul National University R&DB Foundation, Seoul (KR)

(21) Appl. No.: 16/339,724

(22) PCT Filed: Mar. 29, 2018
(86) PCT No.: PCT/KR2018/003694

§ 371 Date: Apr. 5, 2019

(30) Foreign Application Priority Data
Apr. 20, 2017 (KR) 10-2017-0051238
Mar. 19, 2018 (KR) 10-2018-0031485

(51) Int. Cl. B29D 11/00; G02B 3/08; G02B 3/04

(52) U.S. Cl. CPC B29D 11/00836; G02B 3/04; G02B 3/08

(57) ABSTRACT

The present invention relates to a method for manufacturing an aspherical optical member. Compared with conventional cutting-type or drawing-type optical member manufacturing technology, the present invention can mass-produce an aspherical optical member at a low cost by using a simple stacking method, and can manufacture the aspherical optical member without changing a conventional process line.

### TECHNICAL FIELD

The present invention relates to a manufacturing technology for an optical member such as a lens, and more particularly to a method for manufacturing an aspherical optical member.

### BACKGROUND ART

Generally, a cutting method in which an optical composition is formed at a position in which an optical member is disposed and is cut using a machine tool to cut an aspherical surface of the optical member or a drawing method in which a material is melted to form an optical member is used to manufacture an optical member having an aspherical shape.

With the cutting method, high precision machining is possible, but it is difficult to change product design, a defect rate of a product is high, a period of processing time is long, and a processing cost is high. Meanwhile, with the drawing method, since a condition of a high temperature is required to melt a material to form a product, a high cost is required for making a high temperature environment.

### DISCLOSURE

### Technical Problem

The present invention is directed to providing a method for manufacturing an aspherical optical member, which allows an aspherical optical member to be mass-produced at a low cost using a stacking method which is simpler than a conventional cutting method or drawing method for an optical member manufacturing technology and to be manufactured without changing a conventional processing line.

### Technical Solution

One aspect of the present invention provides a method for manufacturing an aspherical optical member including a spherical optical member forming operation in which a discharge nozzle of an optical member manufacturing apparatus discharges an optical composition on a substrate to form a spherical optical member, a spherical optical member curing operation in which a thermal curing unit of the optical member manufacturing apparatus cures the spherical optical member formed on the substrate in the spherical optical member forming operation to form an aspherical optical member having an aspherical refracting surface, an aspherical optical member forming operation in which the discharge nozzle of the optical member manufacturing apparatus further discharges and stacks the optical composition on the spherical optical member cured in the spherical optical member curing operation, and an aspherical optical member curing operation in which the thermal curing unit of the optical member manufacturing apparatus cures and manufactures the aspherical optical member formed in the aspherical optical member forming operation.

The method for manufacturing an aspherical optical member may further include a discharge condition setting operation in which a discharge condition is set through an input portion of the optical member manufacturing apparatus.

In the discharge condition setting operation, at least one of a discharge pressure of the discharge nozzle, a height of the discharge nozzle, and a movement speed of the discharge nozzle may be set as the discharge condition.

In the spherical optical member operation or the aspherical optical member operation, a controller of the optical member manufacturing apparatus may control the discharge pressure of the discharge nozzle, the height of the discharge nozzle, and the movement speed of the discharge nozzle according to the discharge condition set in the discharge condition setting operation.

In the spherical optical member curing operation, the spherical optical member may be partially cured.

The method for manufacturing an aspherical optical member may further include a substrate arranging operation in which the substrate is disposed on a worktable of the optical member manufacturing apparatus.

In the spherical optical member forming operation, the spherical optical member may be formed to have a shape in which at least one longitudinal cylindrical shape is formed along the substrate.

In the spherical optical member forming operation, the spherical optical member may be formed to have a shape in which a plurality of hemispheres or polygons are formed with regular intervals therebetween along the substrate.

In the aspherical optical member forming operation, the aspherical optical member may be formed to have an asymmetric, crater-shaped, elliptic, or bell-shaped cross section.

### Advantageous Effects

According to embodiments of the present invention, there are effects in that an aspherical optical member can be mass-produced at a low cost using a stacking method which is simpler than a conventional cutting or drawing method for an optical member manufacturing technology, and the aspherical optical member can be manufactured without changing a conventional processing line because a processing line of the aspherical optical member does not conflict with the conventional processing line.

### DESCRIPTION OF DRAWINGS

FIG. 1 is a schematic view illustrating an optical member manufacturing apparatus used in a method for manufacturing an aspherical optical member according to the present invention.

FIG. 2 is a flowchart illustrating the method for manufacturing an aspherical optical member according an embodiment of the present invention.

FIGS. 3A to 3D are schematic views illustrating the method for manufacturing an aspherical optical member according to the present invention.

FIG. 4 is a view illustrating a case in which a spherical optical member having a cylindrical shape is formed on a substrate.

FIG. 5 is a view illustrating a case in which spherical optical members having a hemispherical shape are closely formed on a substrate.

FIG. 6 is a view illustrating a case in which spherical optical members having a hemispherical shape are formed on a substrate to be spaced apart from each other by regular intervals.

FIGS. 7A to 7E are views illustrating cross-sectional shapes of aspherical optical members formed on substrates.

FIGS. 8A to 8E are views illustrating external shapes of aspherical optical members formed on substrates.

FIG. 9 is a view illustrating an example of an apparatus for measuring a luminance distribution of the aspherical optical member manufactured using the method for manufacturing an aspherical optical member according to the present invention.

FIG. 10 is a graph showing the luminance distribution of the aspherical optical member measured by the apparatus for measuring a luminance distribution of the aspherical optical member illustrated in FIG. 9.

### MODES OF THE INVENTION

Hereinafter, in order to facilitate understanding and embodiment by those skilled in the art, the present invention will be described in detail by explaining exemplary embodiments with reference to the accompanying drawings. Although specific embodiments are illustrated in the drawings and detailed explanations are described, the embodiments are not intended to limit embodiments of the present invention in the specific forms.

In the description of the invention, when it is determined that detailed descriptions of related well-known functions unnecessarily obscure the gist of the invention, the detailed descriptions thereof will be omitted.

It will be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements.

It will be understood that when an element such as a layer, film, region, plate, or the like is referred to as being “on” another portion, it includes not only the element directly over another element but also another element therebetween. Conversely, when a part is referred to as being “directly on” another part, it means that no intervening elements are present.

Meanwhile, the thickness is enlarged to clearly represent layers and regions in the view. Similar parts are denoted by similar reference numerals throughout this specification.

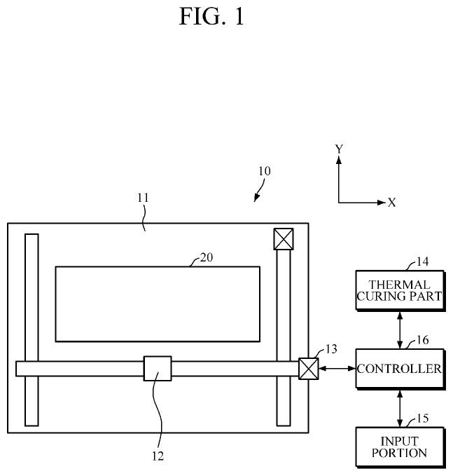

FIG. 1 is a schematic view illustrating an optical member manufacturing apparatus used in a method for manufacturing an aspherical optical member according to the present invention. As illustrated in FIG. 1, the optical member manufacturing apparatus 10 includes a worktable 11, a discharge nozzle 12, a discharge nozzle transfer part 13, a thermal curing unit 14, an input portion 15, and a controller 16.

The worktable 11 is a part in which a substrate 20, on which an aspherical optical member is formed, is disposed. For example, the substrate 20 on which the aspherical optical member is formed may be disposed on the worktable 11 of the optical member manufacturing apparatus 10 using a substrate transfer tray (not shown) or robot arm (not shown).

Meanwhile, the substrate 20 on which the aspherical optical member is formed may be a glass substrate or a display panel of a single panel display apparatus or a multi-panel display apparatus but is not limited thereto and may be an optical substrate such as a laser line generator, a light emitting diode (LED), or a secondary optic which is used in all fields in which optical members may be used.

The discharge nozzle 12 is a part configured to discharge an optical composition 30 on the substrate 20 disposed on the worktable 11 of the optical member manufacturing apparatus 10 and, for example, may be a dispenser having a print scale in a range of 100 μm to 1 cm and may be capable of adjusting a coating condition. In particular, the discharge nozzle 12 may be a piezoelectric dispenser in which a liquid inside a chamber is discharged as the optical composition 30 through a nozzle when a piezoelectric body capable of precisely controlling a coating condition applies a pressure to an inside of the chamber.

However, the discharge nozzle 12 is not limited to a dispenser and may include any part such as an inkjet printer or electrohydrodynamic (EHD) printer capable of discharging the optical composition 30 on the substrate 20.

A process of filling the discharge nozzle 12 with the optical composition 30 may be manually performed by a user or may also be performed by automatically injecting the optical composition 30 using a sensor (not shown) attached in the discharge nozzle 12 when an amount of the optical composition 30 decreases to a predetermined amount or less.

Here, the optical composition 30 may be formed of a material capable of refracting light, for example, may be formed of PDMS (Polydimethylsiloxane) having a refractive index of about 1.45. However, the optical composition 30 is not limited thereto and may include any known material such as an ultraviolet (UV)-curable polymer having a refractive index of about 1.47.

The discharge nozzle transfer part 13 is a part configured to repeatedly transfer the discharge nozzle 12 in a horizontal or/and vertical direction. For example, the discharge nozzle transfer part 13 may include a motor or the like to horizontally and/or vertically transfer the discharge nozzle 12 on a rail at a predetermined speed.

The thermal curing unit 14 is a unit configured to thermally cure the optical composition 30 discharged on the substrate 20. For example, the thermal curing unit 14 may be a UV lamp but is not limited thereto.

The input portion 15 is an input portion for the user to operate. For example, a discharge condition of the optical member manufacturing apparatus 10 may be set through the input portion 15. Here, the discharge condition may be at least one of a discharge pressure of the discharge nozzle, a height of the discharge nozzle, and a movement speed of the discharge nozzle. For example, the input portion 15 may be formed as a button for inputting a discharge condition value but is not limited thereto. The input portion 15 may be formed such that the discharge condition value is input through a computer program.

The controller 16 is a control part, such as a microcomputer, configured to entirely control the optical member manufacturing apparatus 10. For example, the controller 16 may be formed to control the discharge pressure of the discharge nozzle, the height of the discharge nozzle, and the movement speed of the discharge nozzle according to the discharge condition set through the input portion 15.

According to an additional aspect, the input portion 15 may be formed to further set various conditions, such as an external shape of a spherical optical member formed on the substrate, a cross-sectional shape of a aspherical optical member, an arrangement shape thereof, and the like, as well as setting the discharge condition.

In this case, the spherical optical member formed on the substrate may have an external shape in which at least one longitudinal cylindrical shape is formed along the substrate, or a shape in which a plurality of hemispheres or polygons are formed with regular intervals therebetween along the substrate, but the present invention is not limited thereto.

Meanwhile, the aspherical optical member formed on the substrate may have an asymmetric, crater-shaped, elliptic, or bell-shaped cross section but is not limited thereto.

The controller 16 may control the discharge pressure of the discharge nozzle, the height of the discharge nozzle, the movement speed of the discharge nozzle, and the like according to setting of the external shape of the spherical optical member formed on the substrate, the cross-sectional shape of the aspherical optical member, the arrangement shape, and the like to form the spherical optical member or the aspherical optical member in the set arrangement shape such that the external shape of the spherical optical member has the set shape, or the cross-sectional shape of the aspherical optical member has the set shape.

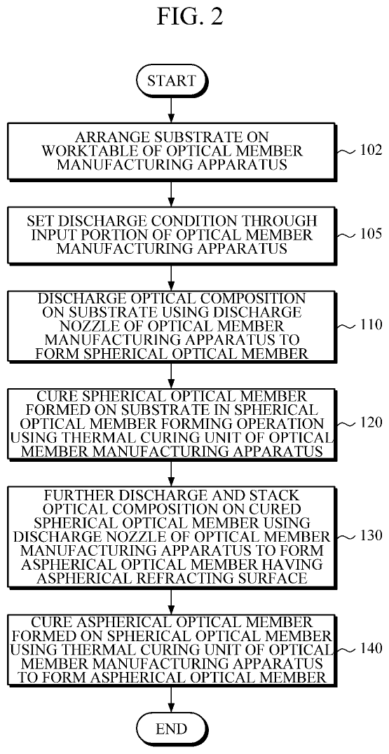

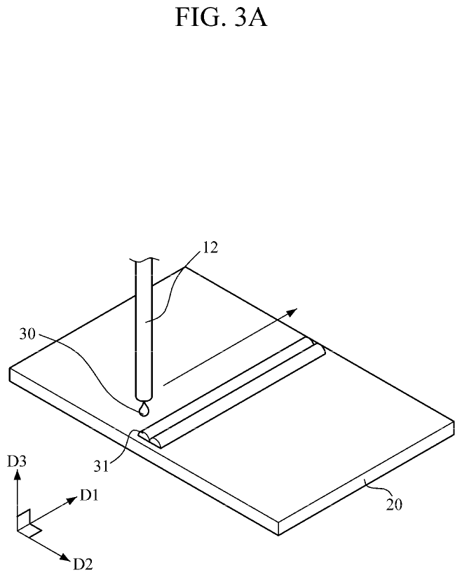

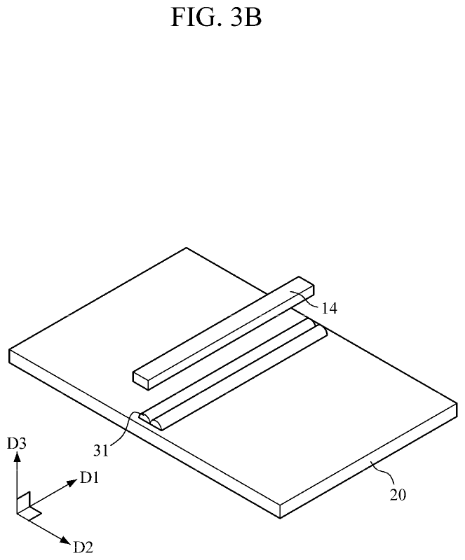

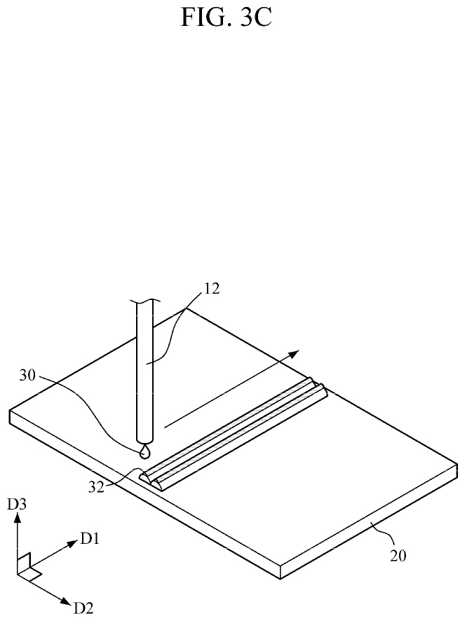

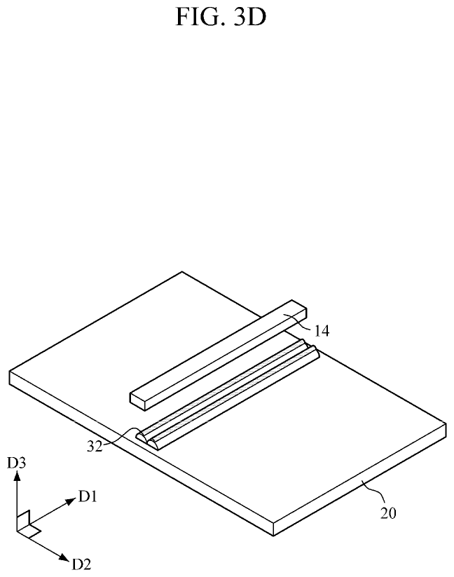

FIG. 2 is a flowchart illustrating the method for manufacturing an aspherical optical member according an embodiment of the present invention, and FIGS. 3A to 3D are schematic views illustrating the method for manufacturing an aspherical optical member according to the present invention.

As illustrated in FIG. 2, the method for manufacturing an aspherical optical member according to an embodiment includes a spherical optical member forming operation (110), a spherical optical member curing operation (120), an aspherical optical member 130 forming operation, and an aspherical optical member curing operation (140).

First, in the spherical optical member forming operation (110), the discharge nozzle 12 of the optical member manufacturing apparatus 10 discharges the optical composition 30 on the substrate 20 to form the spherical optical member. At this time, the optical composition 30 may be PDMS having a refractive index of about 1.45, a UV-curable polymer having a refractive index of about 1.47, or the like, which can refract light. Referring to FIG. 3A, it can be seen that the discharge nozzle 12 discharges the optical composition 30 on the substrate 20 to form the spherical optical member 31.

For example, the spherical optical member 31 formed on the substrate 20 may have an external shape in which at least one longitudinal cylindrical shape is formed along the substrate, or a shape in which a plurality of hemispheres or polygons are formed with regular intervals therebetween along the substrate.

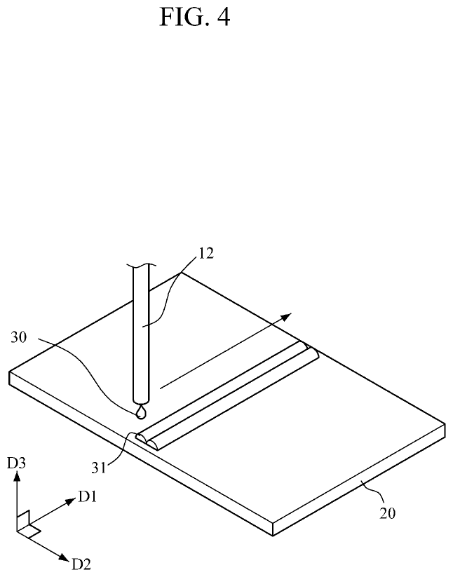

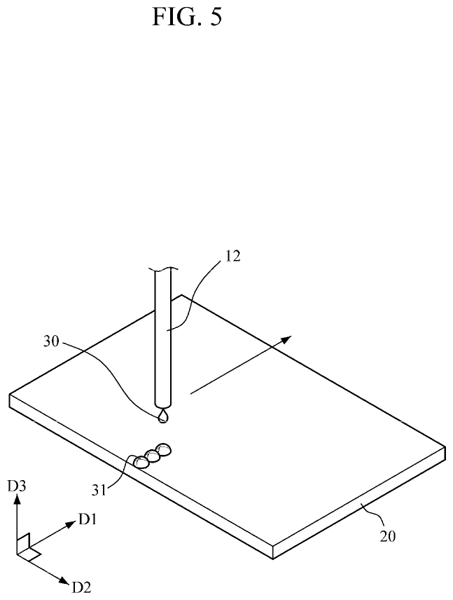

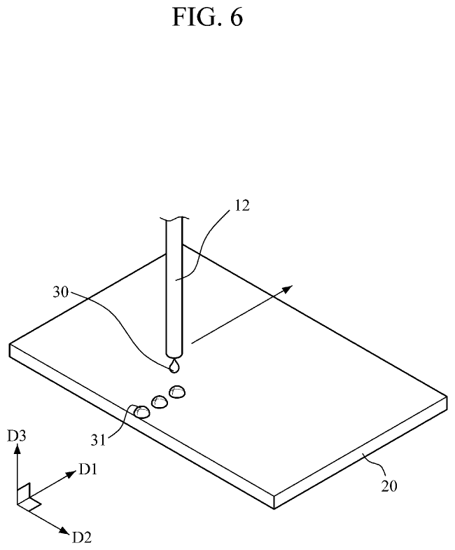

FIG. 4 is a view illustrating a case in which spherical optical members having the cylindrical shape are formed on the substrate, FIG. 5 is a view illustrating a case in which spherical optical members having a hemispherical shape are closely formed on the substrate, and FIG. 6 is a view illustrating a case in which spherical optical members having a hemispherical shape are formed on the substrate to be spaced apart from each other by regular intervals.

Next, in the spherical optical member curing operation (120), the thermal curing unit 14 of the optical member manufacturing apparatus 10 cures the spherical optical member 31 formed on the substrate 20 in the spherical optical member forming operation (110). Here, the thermal curing unit 14 may be a UV lamp but is not limited thereto. Referring to FIG. 3B, it can be seen that the thermal curing unit 14 thermally cures the spherical optical member 31 formed on the substrate 20.

Meanwhile, in the spherical optical member curing operation (120), the spherical optical member 31 may be partially cured. Since, when the spherical optical member 31 is fully cured and the optical composition 30 is further stacked on the spherical optical member 31, irregular patterns may be formed so that reproducibility of the aspherical optical member may decrease, the spherical optical member 31 may be partially cured to prevent a phenomenon in which the reproducibility of manufacturing of the aspherical optical member decreases in the spherical optical member curing operation (120).

Next, in the aspherical optical member forming operation (130), the discharge nozzle 12 of the optical member manufacturing apparatus 10 further discharges and stacks the optical composition 30 on the spherical optical member cured in the spherical optical member curing operation (120) to form the aspherical optical member 32 having an aspherical refracting surface. Referring to FIG. 3C, it can be seen that the discharge nozzle 12 further discharges the optical composition 30 on the cured spherical optical member to form the aspherical optical member 32.

For example, the aspherical optical member 32 formed on the substrate may have an asymmetric, crater-shaped, elliptic, or bell-shaped cross section but is not limited thereto.

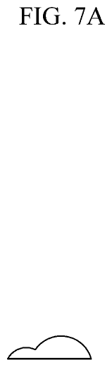

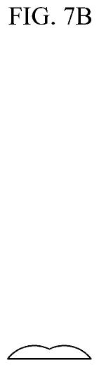

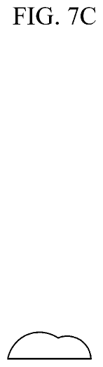

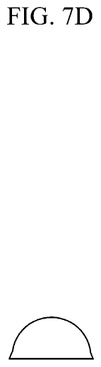

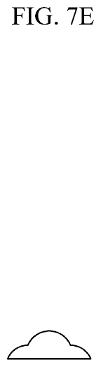

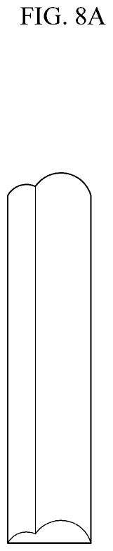

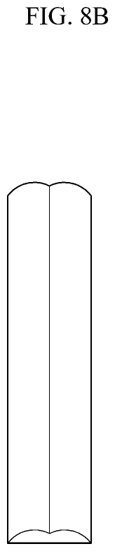

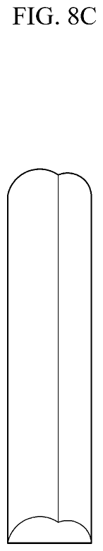

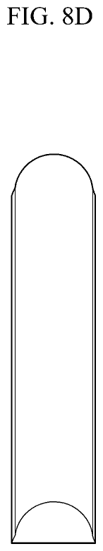

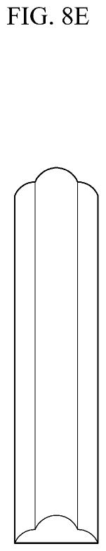

FIGS. 7A to 7E are views illustrating cross-sectional shapes of the aspherical optical member formed on the substrate, and FIGS. 8A to 8E are views illustrating external shapes of the aspherical optical member formed on the substrate. FIGS. 7A and 8A are views illustrating asymmetric exteriors thereof, FIGS. 7B and 8B are views illustrating crater-shaped exteriors thereof, FIGS. 7C and 8C are views illustrating horizontal elliptic exteriors thereof, FIGS. 7D and 8D are views illustrating vertical elliptic exteriors thereof, and FIGS. 7E and 8E are views illustrating bell-shaped exteriors thereof.

Next, in the aspherical optical member curing operation (140), the thermal curing unit 14 of the optical member manufacturing apparatus 10 cures the aspherical optical member 32 formed in the aspherical optical member forming operation (130) to form the aspherical optical member. Here, the thermal curing unit 14 may be a UV lamp but is not limited thereto. Referring to FIG. 3D, it can be seen that the thermal curing unit 14 thermally cures the aspherical optical member 32 formed on the substrate 20.

For example, the aspherical optical member having the asymmetric shape is manufactured by forming and curing the cylindrical spherical optical member having the cylindrical shape on the substrate, laterally moving the discharge nozzle by a half width of the spherical optical member, discharging the optical composition once more in the same discharge condition of the forming of the spherical optical member such that the cylindrical spherical optical member is formed, and forming and curing the aspherical optical member having the aspherical refracting surface.

For example, the crater-shaped aspherical optical member is manufactured by forming and curing the spherical optical member having the cylindrical shape on the substrate, laterally moving the discharge nozzle by the width of the spherical optical member, discharging the optical composition once more in the same discharge condition of the forming of the spherical optical member such that the cylindrical spherical optical member is formed, and forming and curing the aspherical optical member having the aspherical refracting surface.

For example, the aspherical optical member having the elliptic shape is manufactured by forming and curing the spherical optical member having the cylindrical shape on the substrate, moving the discharge nozzle upward by a height of the spherical optical member, discharging the optical composition once more in the same discharge condition of the forming of the spherical optical member such that the cylindrical spherical optical member is formed, and forming and curing the aspherical optical member having the aspherical refracting surface.

For example, the bell-shaped aspherical optical member is manufactured by forming and curing the spherical optical member having the cylindrical shape on the substrate, moving the discharge nozzle upward by the height of the spherical optical member, discharging the optical composition in a discharge condition different from the condition in the forming of the spherical optical member (for example, a discharge pressure of the discharge nozzle is decreased or a movement speed of the discharge nozzle is adjusted to be fast) such that the cylindrical spherical optical member is formed, and forming and curing the aspherical optical member having the aspherical refracting surface.

With the above-described method, since an aspherical optical member is not formed using a conventional cutting or drawing method for an optical member manufacturing technology, but an add-on method in which the optical composition is stacked on the spherical optical member to manufacturing the aspherical optical member having the aspherical refracting surface is used, the aspherical optical member may be simply and inexpensively mass-produced compared to the conventional cutting or drawing method for the optical member manufacturing technology, and the aspherical optical member may be manufactured without changing an existing conventional processing line because a processing line of the aspherical optical member does not conflict therewith.

The add-on method is a bottom-up stacking method of stacking upward from a bottom, which is opposite to a cutting method which is a top-down method of cutting downward from a top to a bottom.

Meanwhile, according to an additional aspect of the present invention, the method for manufacturing an aspherical optical member may further include a discharge condition setting operation (105). The discharge condition is set through the input portion 15 of the optical member manufacturing apparatus 10 in the discharge condition setting operation (105).

For example, in the discharge condition setting operation (105), at least one of the discharge pressure of the discharge nozzle, the height of the discharge nozzle, and the movement speed of the discharge nozzle may be set, but the present invention is not limited thereto. Various conditions may be set in the setting of the discharge condition to form the aspherical optical member having the aspherical refracting surface according to properties of the optical composition 30 such as a viscosity, a transmittance, a refractive index, and the like and properties of the substrate 20 such as hydrophilicity, hydrophobicity, and the like, and properties of a surrounding environment such as a temperature and the like.

When the discharge condition is set in the discharge condition setting operation (105), the controller 16 of the optical member manufacturing apparatus 10 controls the discharge pressure of the discharge nozzle, the height of the discharge nozzle, and the movement speed of the discharge nozzle in the spherical optical member forming operation (110) or the aspherical optical member forming operation (130) according to the discharge condition set in the discharge condition setting operation (105).

As described above, when the discharge condition is set in the discharge condition setting operation (105), the aspherical optical members having various cross sections such as an asymmetric, crater-shaped, elliptic, and bell-shaped cross sections may be formed.

For example, according to the cross-sectional shape of the aspherical optical member to be manufactured, the discharge pressure may be set in the range of 50 kPa to 800 kPa, the height of the discharge nozzle may be set to about 200 μm, and the movement speed of the discharge nozzle may be set in the range of 10 mm/s to 40 mm/s.

Meanwhile, according to an additional aspect of the present invention, the method for manufacturing an aspherical optical member may further include a substrate arranging operation (102). The substrate 20 is disposed on the worktable 11 of the optical member manufacturing apparatus 10 in the substrate arranging operation (102).

For example, in the substrate arranging operation (102), the substrate 20 on which the aspherical optical member is formed is disposed on the worktable 11 of the optical member manufacturing apparatus 10 using the substrate transfer tray (not shown), robot arm (not shown), or the like.

As a result, an entire process, from the process of arranging the substrate 20 on which the aspherical optical member is formed on the worktable 11 of the optical member manufacturing apparatus 10 to the process of forming and curing the spherical optical member on the substrate 20 and stacking the optical composition on the spherical optical member to form and cure the aspherical optical member having the aspherical refracting surface, can be automated.

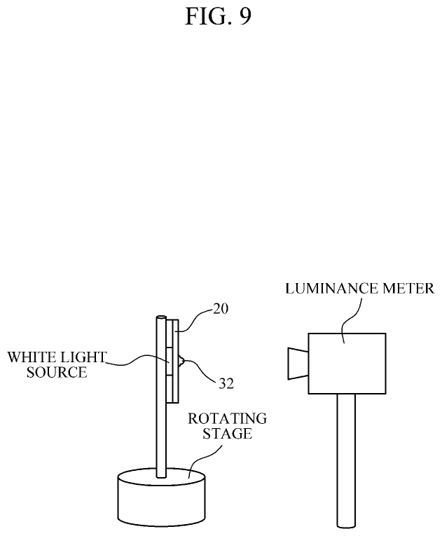

FIG. 9 is a view illustrating an example of an apparatus for measuring a luminance distribution of the aspherical optical member manufactured using the method for manufacturing an aspherical optical member according to the present invention. The aspherical optical member 32 manufactured using the method for manufacturing an aspherical optical member according to the present invention is positioned in front of a white LED installed in a rotation stage, and luminance is measured using a luminance meter while the aspherical optical member 32 rotates with respect to the front.

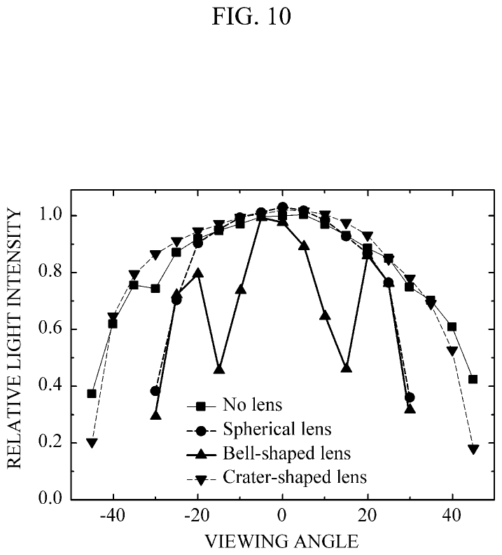

FIG. 10 is a graph showing the luminance distribution of the aspherical optical member measured by the apparatus for measuring a luminance distribution of the aspherical optical member illustrated in FIG. 9. The luminance distribution of each of the cases, in which an aspherical optical member is not used, in which the spherical optical member is used, in which the bell-shaped aspherical optical member is used, and in which the crater-shaped aspherical optical member is used, is measured using the apparatus for measuring the luminance distribution of the aspherical optical member, which is illustrated in FIG. 9, and it can be seen that the luminance distribution varies according to a kind of the optical member as a result.

Referring to FIG. 10, when compared with the conventional spherical optical member, in the case of the bell-shaped aspherical optical member, the luminance decreases at a certain angle compared with a conventional spherical optical member, and in the case of the crater-shaped aspherical optical member, it can be seen that there is an effect of widening a range of the luminance distribution.

As described above, the aspherical optical member can be mass-produced at a low cost using the stacking method which is simpler than the conventional cutting or drawing method for the optical member manufacturing technology, and the aspherical optical member can be manufactured without changing an existing processing line because a processing line of the aspherical optical member does not conflict with the existing processing line such that the objective of the present invention can be achieved.

The various embodiments disclosed in this specification and drawings are only specific examples to help understanding of the invention and are not intended to limit various embodiments of the present invention.

Accordingly, the scope of various embodiments of the present invention should not be limited by the above-described embodiments, and all changes or modifications derived from the technical ideas of various embodiments of the present invention should be construed as being included in the scope of various embodiments of the present invention.

### INDUSTRIAL APPLICABILITY

The present invention is industrially applicable in the technical field related to manufacturing of an optical member such as a lens and the like and its application field.

1. A method for manufacturing an aspherical optical member comprising:
a spherical optical member forming operation in which a discharge nozzle of an optical member manufacturing apparatus discharges an optical composition on a substrate to form a spherical optical member;
a spherical optical member curing operation in which a thermal curing unit of the optical member manufacturing apparatus cures the spherical optical member formed on the substrate in the spherical optical member forming operation;
an aspherical optical member forming operation in which the discharge nozzle of the optical member manufacturing apparatus further discharges and stacks the optical composition on the spherical optical member cured in the spherical optical member curing operation to form an aspherical optical member having an aspherical refracting surface; and
an aspherical optical member curing operation in which the thermal curing unit of the optical member manufacturing apparatus cures and manufactures the aspherical optical member formed in the aspherical optical member forming operation.

2. The method of claim 1, further comprising a discharge condition setting operation in which a discharge condition is set through an input portion of the optical member manufacturing apparatus.

3. The method of claim 2, wherein, in the discharge condition setting operation, at least one of a discharge pressure of the discharge nozzle, a height of the discharge nozzle, and a movement speed of the discharge nozzle is set as the discharge condition.

4. The method of claim 3, wherein, in the spherical optical member operation or the aspherical optical member operation, a controller of the optical member manufacturing apparatus controls the discharge pressure of the discharge nozzle, the height of the discharge nozzle, and the movement speed of the discharge nozzle according to the discharge condition set in the discharge condition setting operation.

5. The method of claim 1, wherein, in the spherical optical member curing operation, the spherical optical member is partially cured.

6. The method of claim 1, further comprising a substrate arranging operation in which the substrate is disposed on a worktable of the optical member manufacturing apparatus.

7. The method of claim 1, wherein, in the spherical optical member forming operation, the spherical optical member is formed to have a shape in which at least one longitudinal cylindrical shape is formed along the substrate.

8. The method of claim 7, wherein, in the aspherical optical member forming operation, the aspherical optical member is formed to have an asymmetric, crater-shaped, elliptic, or bell-shaped cross section.

9. The method of claim 1, wherein, in the spherical optical member forming operation, the spherical optical member is formed to have a shape in which a plurality of hemispheres or polygons are formed with regular intervals therebetween along the substrate.

10. The method of claim 9, wherein, in the aspherical optical member forming operation, the aspherical optical member is formed to have an asymmetric, crater-shaped, elliptic, or bell-shaped cross section.
